(19) United States
(12) Patent Application Publication
(10) Pub. No.: US 2017/0200110 A1
(43) Pub. Date: Jul. 13, 2017

(54) EVENT RECORDING

(71) Applicant: Ryan C. Rojo, Salida, CA (US)

(72) Inventor: Ryan C. Rojo, Salida, CA (US)

(21) Appl. No.: 14/992,140

(22) Filed: Jan. 11, 2016

(51) Int. Cl. G06Q 10/06; G06Q 50/00; H04L 12/58

(52) U.S. Cl. CPC G06Q 10/063112; H04L 51/32; H04L 51/10; G06Q 50/01

(57) ABSTRACT

A method to enable a user to record an event on an electronic device and share said recorded event over a social computing based means at a geographically remote location by employing a person located at the geographically remote location is disclosed. The method may be implemented to enable a person to find, contact and communicate with people all over the world either to use their services for making remote recording and/or storing and/or sharing of videos and photos, or render services for the same. In the method, a social computing based means is implemented that enables its users to connect with other users for the aforementioned purpose. Said social computing based means can be accessed and used from a user's communication device using an internet connection.

### FIELD OF THE INVENTION

The invention relates generally to recording of an event on an electronic device and share said recorded event over a social computing based means.

### BACKGROUND OF THE INVENTION

A person obtains an image photographed at a desired location by hiring a photographer on a photographing assignment or by traveling to the location to photograph the image himself. When an image of a distant location is desired, the photographer must spend a considerable length of time traveling to the location. For this reason, a current image of the location cannot be obtained easily. In addition, even though a photographer currently present in the vicinity of the desired photographing location may be hired on assignment, it takes time to find out the photographer's schedule and contact number. As a solution to the problems discussed above, the inventor of the present invention conceived a system through which a service that accepts a photographing request placed by a third party who is not an acquaintance or a friend and contracts a third party on a photographing assignment is provided.

A person visiting a given location may decide that he would like to obtain an image photographed at the same location but on a different day or in a different season. In such a case, he needs to hire a photographer for a photographing assignment at a later date or to go back to the location himself to photograph the image. As a solution to this problem, the inventor of the present invention has conceived a system through which a brokering service that brokers images having been photographed in the past by third parties who are not friends or acquaintances is provided.

Furthermore, networks of digital cameras and digital devices are setup to share information including images, and can be operated remotely when connected to a network. Typically, the digital cameras are setup as dedicated image capture devices that can only be operated by remote controllers that can control the image capture timing, pointing or zoom. Alternately, the digital devices are setup to allow images that have been captured to be shared with another digital device.

Some prior art patents are as follows: U.S. Pat. No. 6,400,903 entitled “Remote Camera Relay Controller Method and Apparatus” issued to Conoval discloses a method and apparatus to adapt a digital camera for unattended remote use of the digital camera. The digital camera is controlled remotely by a relay station that retransmits the image data. The digital camera is controlled for field of view, pan, tilt and windowing. However, this approach requires that the digital camera be connected to a network and setup specifically for dedicated remote operation through the relay station by another digital device. U.S. Pat. No. 6,535,243 issued to Tullis discloses a method for allowing digital cameras access to a large amount of digital image data by using a bidirectional communication medium between the digital camera and a host computer. The method proposed by Tullis focuses on image storage and not image capture.

U.S. Pat. No. 7,154,535 issued to Yamasaki discloses a method for accessing images through a wired or wireless interface to image data resident on another digital camera. Following the method described by Yamasaki, an image is captured by a device and the image along with capture data is sent to another digital device for storage. U.S. Pat. No. 7,139,018 issued to Grosvenor teaches the sharing of digital images amongst a group of people with image capture devices at the same event. The images are downloaded from the image capture devices to a shared storage location. The images are all labeled with a synchronizing code to enable image sharing of only the images from the event.

None of the above inventions and patents, taken either singly or in combination, are seen to disclose a method to enable a user to record an event on an electronic device and share said recorded event over a social computing based means at a geographically remote location by employing a person located at the geographically remote location.

### SUMMARY OF THE INVENTION

A method to enable a user to record an event on an electronic device and share said recorded event over a social computing based means at a geographically remote location by employing a person located at the geographically remote location is disclosed. The method may be implemented to enable a person to find, contact and communicate with people all over the world either to use their services for making remote recording and/or storing and/or sharing of videos and photos, or render services for the same. In the method, a social computing based means is implemented that enables its users to connect with other users for the aforementioned purpose. Said social computing based means can be accessed and used from a user's communication device using an internet connection.

The method implements a Graphical User Interface operable with the means for control and navigation of the user's communication device that enables the user to use the various means provided through the social computing based means to perform actions related to making remote recording and/or storing and/or sharing of videos and photos, or render services for the same. Upon registering with the social computing based means, a user may decide to either use or render services provided by other users registered with the social computing based means, or use and render services simultaneously. The social computing based means enables a user to act either as a user who provides services to other users as a user to record, store and share video, pictures and like or act as an end user to use services provided by other users, or act as all simultaneously. An end user is a user who needs an event to be recorded, stored and shared for him/her by another user. A recoding user is a user who provides services for recording, storing and sharing an event for end users.

In the method, through the social computing based means, a means is provided to the user to create a user account and the user account enables access to the social computing based means. A means is provided to the user to provide information associated with the user and to interact and communicate with the other users having accounts associated with the social computing based means. Information provided by the user through his/her user account may be presented on a profile associated with the user account. The profile maybe viewed by the other users having accounts associated with the social computing based means.

In the method, through social computing based means, a means is provided to the user to post at least one information item, which can be a text message or a video clip or an audio clip or an image or any combination thereof. The information item may be used to post pitches, or requirements or advertisements or any other such information. The method involves providing, through the social computing based means, a means to the user to view at least one news item posted by the other users, which can be a text message or a video clip or an audio clip or an image or any combination thereof. The news item may be pitches or requirements or advertisements or any other such information posted by other users. The method involves providing, through the social computing based means, a means to the user to view a web feed, which can be either an information item or a news item. The method involves providing, through the social computing based means, a payment mechanism means to facilitate monetary transactions between the user and the other users.

The method comprises providing the following through social computing based means a means to an end user to locate at least one recoding user available for engagement in recording of a desired event for end user; a means to the end user to view a list of recording users with their associated information which assist and allow the users to choose a suitable recording user in order to purchase the desired event; a means to the end user for interacting with the suitable recoding user for making a request to the suitable recoding user for making the recoding; and a means to the suitable recoding user to accept the request for recoding the at least one item to be purchased. The method involves providing, through the social computing based means, a means to display the user's service availability status.

### DETAILED DESCRIPTION OF THE INVENTION

The method involves providing, through a social computing based means, a means to a user to create a user account, wherein the user account enables the user to access the social computing based means. In the method, through social computing based means, a means is to the user to provide information associated with the user, communicate and interact with other users having accounts associated with the social computing based means. The method involves providing through the social computing based means, a means to the user to post at least one information item over the social computing based network.

The method involves providing, through the social computing based means, a means to the user to view at least one news item posted by the other users; a payment mechanism means to facilitate monetary transactions between the user and the other users. Further the method comprises of providing, through the social computing based means, a means to display the user's service availability status, a means to the end user to view at least one employee suggestion. The method involves providing, through the social computing based means, a means to an end user for locating at least one recording user available for engagement in recording of at least one event to be recorded, a means to the end user for viewing information about the at least one recording user as a list of recording user; a means to the end user for selecting a suitable recording user from the list of recording user; a means to the end user for interacting with the suitable recording user for making a request to the suitable recording user to perform a recording of at least one event to be recorded, a means to the suitable recording user for accepting the request to perform the recording. Moreover, the method involves providing, through the social computing based means, a means to enable recording event. The method comprises capturing a multimedia file using a digital camera system, storing the multimedia file with metadata associated with the multimedia file; and, posting the multimedia file with metadata associated to the end user via the social computing based means.

This method may be implemented to enable a person to find, contact and communicate with people all over the world either to use their services for making remote recording and/or storing and/or sharing of videos and photos, or render services for the same. In the method, a social computing based means is implemented that enables its users to connect with other users for the aforementioned purpose. The social computing based means can be accessed and used from a user's communication device using an internet connection. The method implements a Graphical User Interface operable with the means for control and navigation of the user's communication device that enables the user to use the various means provided through the social computing based means to perform actions related to making remote recording and/or storing and/or sharing of videos and photos, or render services for the same. The method involves providing, through the social computing based means, a means to the user to view at least one news item posted by the other users, which can be a text message or a video clip or an audio clip or an image or any combination thereof. The news item may be pitches or requirements or advertisements or any other such information posted by other users.

The method involves providing, through the social computing based means, a means to the user to view a web feed, which can be either an information item or a news item. The method involves providing, through the social computing based means, a payment mechanism means to facilitate monetary transactions between the user and the other users. The method comprises providing the following through social computing based means a means to an end user to locate at least one recoding user available for engagement in recording of a desired event for end user; a means to the end user to view a list of recording users with their associated information which assist and allow the users to choose a suitable recording user in order to purchase the desired event; a means to the end user for interacting with the suitable recoding user for making a request to the suitable recoding user for making the recoding; and a means to the suitable recoding user to accept the request for recoding the at least one item to be purchased. The method involves providing, through the social computing based means, a means to display the user's service availability status. The present invention can be implemented on any communication device that has hardware components that can perform wireless and wired communication, such as (but not limited to)—multi-purpose pocket computers, personal multimedia devices, etc. The various devices on which the applications that implement the present invention run may use one or more processors with different instruction-sets, architectures, clock-speeds, etc. and memory that may include high speed random access memory and may include non-volatile memory, such as one or more magnetic disk storage devices, flash memory devices, and other kinds of solid state memory devices.

The various applications that can implement the present invention run on electronic devices that may use at least one physical user interface device that provide the means of control and navigation within the operating system. Applications that run on the devices include (but are not limited to) touch-pads, such as those described in (but not limited to)—(1) U.S. patent application Ser. No. application number: 10/722,948 (“Touch pad for handheld device”, filed Nov. 25, 2003); (2) U.S. patent application Ser. No. application number: 10/188,182(“Touch pad for handheld device”, filed Mar. 21, 2006); (3) U.S. patent application Ser. No: 08/210,610 (“Computer system with touchpad support in operating system”, filed Mar. 18, 1994); (4) U.S. patent application Ser. No. 643,256 (“Movable touch pad with added functionality”, filed 10/643,256), touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheels, such as those described in U.S. patent application Ser. No. 11/549,619 “Method, device, and graphical user interface for dialing with a click wheel” filed on Oct. 13, 2006 , keyboards, such as those mentioned in (but not limited to) U.S. patent application Ser. No. 07/711,760 (“Ergonomic keyboard input device” , filed on Jun. 6, 1991) , mouse, such as those described in (but not limited to) (1) application Ser. No.: 09/167,314 (“Computer mouse with enhance control button (s) “, filed on Oct. 6, 1998); (2) application Ser. No.: 08/288,945 (“Roller mouse for implementing scrolling in windows applications “, filed on Aug. 10, 1994) and gesture recognition means, such as those described in (but not limited to) (1) European Patent application publication number: EP2482176 A2 (“Multi-input gesture control for a display screen”, filed on Nov. 4, 2011) and (2) U.S. patent application with publication No. 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and these electronic devices. Connectivity of these devices with networks, such as the internet, an intranet and/or wireless network, such as cellular telephone network, a wired or wireless local area network (LAN) and/or metropolitan area network (MAN) and/or WAN (wide area network) and other wireless communication is achieved by use of a plurality of communication standards, protocols and technologies like Bluetooth, Wireless Fidelity (Wi-Fi) and/or any other suitable communication protocol, including communication protocols not yet developed as of the filing date of this document.

The present invention maybe implemented on applications that run on a single or variety of operating system platforms, including but not limited to OS X, WINDOWS, UNIX, IOS, ANDROID, SYMBIAN, LINUX, or embedded operating systems, such as VxWorks. The present invention may also be implemented to work with various web browsers, including but not limited to Internet Explorer, Mozilla Firefox, Safari, and Opera, that access and handle various types of web pages constructed with various mark-up languages, such as HTML, HTML-5, XHTML, XML, etc. and the associated CSS (cascading style sheet) files and java-script files. The present invention is implementable with communication devices that are enabled with Global Positioning System (GPS) unit. Using the GPS capabilities of the communication device, various aspects of the invention such as locating users for providing services, providing job suggestions, providing employee suggestions and implementing the route learning algorithm are achieved. APIs may interface various modules that may be used for implementing the various means provided to the users through the social computing based means.

The social computing based means may be realized using (but not limited to) one or more servers, one or more database and networks associated with the servers and one or more software modules running on the servers. The social computing based means may be accessed and used from the communication devices of the users of the social computing based means as an application software or a website that runs/executes on these the communication devices. The application software or the website exchange data with the servers over an internet connection. The method to enable a user to record an event on an electronic device and share the recorded event over a social computing based means. Although the invention has been explained in relation to its preferred embodiment, it is to be understood that many other possible modifications and variations can be made without departing from the spirit and scope of the invention.

What is claimed is:

1. A computer implemented method to enable a user to record an event on an electronic device and share said recorded event over a social computing based means, method comprising the following steps:
providing, through a social computing based means, a means to a user to create a user account wherein said user account enables said user to access said social computing based means;
providing, through said social computing based means, a means to said user to provide information associated with said user, communicate and interact with other users having accounts associated with said social computing based means;
providing, through said social computing based means, a means to said user to post at least one information item over said social computing based network;
providing, through said social computing based means, a means to said user to view at least one news item posted by said other users;
providing, through said social computing based means, a payment mechanism means to facilitate monetary transactions between said user and said other users;
providing, through said social computing based means, a means to display said user's service availability status;
providing, through said social computing based means, a means to said end user to view at least one employee suggestion;
providing, through said social computing based means, a means to an end user for locating at least one recording user available for engagement in recording of at least one event to be recorded;
providing, through said social computing based means, a means to said end user for viewing information about said at least one recording user as a list of recording user;
providing, through said social computing based means, a means to said end user for selecting a suitable recording user from said list of recording user;
providing, through said social computing based means, a means to said end user for interacting with said suitable recording user for making a request to said suitable recording user to perform a recording of at least one event to be recorded;
providing, through said social computing based means, a means to said suitable recording user for accepting said request to perform said recording;
providing, through said social computing based means, a means to enable recording event comprises:
capturing a multimedia file using a digital camera system;
storing said multimedia file with metadata associated with said multimedia file; and
posting said multimedia file with metadata associated to said end user via said social computing based means.

2. The method as set forth in claim 1, wherein said social computing based means comprises an application software.

3. The method as set forth in claim 1, wherein said social computing based means comprises a website.

4. The method as set forth in claim 1, wherein said web feed comprises said at least one information item.

5. The method according to claim 1 wherein said web feed comprises said at least one news item.

6. The method according to claim 1, wherein said employee suggestion is based on activity performed by said end user.

7. The method according to claim 1, wherein said employee suggestion is based on the browsing history of said end user.

8. The method according to claim 1, wherein said employee suggestion comprises presenting to said end user an employee information.

9. The method according to claim 1, wherein said employee information comprises information associated with said recording user.
